(19) United States
(12) Patent Application Publication
(10) Pub. No.: US 2014/0111057 A1
(43) Pub. Date: Apr. 24, 2014

(54) STATOR AND ROTARY ELECTRIC MACHINE

(71) Applicants: Akira Takasaki, Toyota-shi (JP); Hiroshi Kaneiwa, Chiryu-shi (JP)

(72) Inventors: Akira Takasaki, Toyota-shi (JP); Hiroshi Kaneiwa, Chiryu-shi (JP)

(73) Assignee: TOYOTA JIDOSHA KABUSHIKI KAISHA, Toyota-shi, Aichi-ken (JP)

(21) Appl. No.: 14/124,503

(22) PCT Filed: Jun. 6, 2012
(86) PCT No.: PCT/IB2012/001087

§ 371 Date: Dec. 6, 2013

(30) Foreign Application Priority Data
Jun. 14, 2011 (JP) 2011-132122

(51) Int. Cl. H02K 3/28

(52) U.S. Cl. CPC H02K 3/28
USPC 310/208

(57) ABSTRACT

A first insulation-coated conductive wire of a first coil forming body is positioned between one conductive wire exposed region, from among the conductive wire exposed regions that are positioned on both sides of a curved portion positioned on an outermost periphery of a coil assembly, and a second insulation-coated conductive wire that forms the curved portion, and the first coil forming body is different from a second coil forming body that has the second insulation-coated conductive wire, and the first insulation-coated conductive wire of the first coil forming body forms another curved portion.

### BACKGROUND OF THE INVENTION

1. Field of the Invention

The invention relates to a stator and a rotary electric machine.

2. Description of Related Art

A rotary electric machine provided with a stator having a coil assembly of a three-phase distributed winding stator structure is described in Japanese Patent Application Publication No. 2003-018778 (JP 2003-018778 A), Japanese Patent Application Publication No. 2010-081771 (JP 2010-081771 A), and Japanese Patent Application Publication No. 2001-238386 (JP 2001-238386 A), for example. The coil assembly used in this stator is such that an insulation-coated conductive wire, in which a conductive wire is coated with an insulation coating, is formed in a concavo-convex shape while a generally U-shaped portion having a convex portion alternately reverses, and is wound in a circular pattern along a circumferential direction.

This kind of coil assembly has an annular (i.e., circular) shape, on the whole. Also, with this coil assembly, a plurality of conductive wire exposed regions where the conductive wire of the insulation-coated conductive wire is exposed are provided along an outer peripheral side on one end side, in the direction of a rotation axis, of the coil assembly, and the setting of a creepage distance between two adjacent conductive wire exposed regions (i.e., the shortest distance between conductive wire portions along an insulator surface) is extremely important for stabilizing the function of the stator. This coil assembly is formed by a plurality of coil forming bodies, each coil forming body having a structure that is wound while increasing in diameter in the circumferential direction.

In the conductive wire exposed regions, conductors of end portions of the insulation-coated conductive wire that is coated with insulation are exposed, and these end portions are joined together by welding or the like, such that U-phase, V-phase, and W-phase coils are formed. However, in this coil assembly, when the plurality of conductive wire exposed regions are arranged close together, the creepage distance between two adjacent conductive wire exposed regions may become short.

### SUMMARY OF THE INVENTION

Thus, the invention provides a stator having a structure that enables a creepage distance between a plurality of conductive wire exposed regions that are arranged on an outer peripheral surface of a coil assembly to be maintained, and a rotary electric machine provided with this stator.

A first aspect of the invention relates to a stator. The stator includes an annular coil assembly around a center axis of the stator. The coil assembly is formed from a plurality of coil forming bodies. Each coil forming body includes i) a coil region that is formed in a concavo-convex shape with generally U-shaped portions, each having a protruding portion, reversing alternately, formed by an insulation-coated conductive wire in which a conductive wire is coated with an insulation coating, and that is wound in an annular shape along a circumferential direction, and ii) a plurality of conductive wire exposed regions that are provided on end portions of the coil region, and in which the conductive wire is exposed, and that are arranged at predetermined intervals along an outer peripheral side on one end side of the coil assembly in a direction in which the center axis extends. The protruding portion has a curved portion that increases in diameter on an outside in a radial direction, when the coil region is wound along the circumferential direction. Between one of the conductive wire exposed regions, from among the conductive wire exposed regions that are positioned on both sides of one of the curved portions positioned on an outermost periphery of the coil assembly, and the insulation-coated conductive wire that forms the one curved portion, is positioned the insulation-coated conductive wire of one of the coil forming bodies that is different from another of the coil forming bodies that has the insulation-coated conductive wire. The insulation-coated conductive wire of the one coil forming body forms another of the curved portions.

In this aspect, each of the curved portions positioned on the outermost periphery of the coil assembly may be positioned in substantially a center between the conductive wire exposed regions that are adjacent in the circumferential direction.

In the aspect described above, the conductive wire exposed regions may be provided extending toward the outside in the radial direction.

In the aspect described above, the conductive wire exposed regions may be positioned to an outside of an outer surface of the coil region that is positioned on an outermost side in the radial direction of the coil assembly.

In the aspect described above, the coil assembly may be formed by a plurality of coil forming body sets, each of which is formed by four of the coil forming bodies.

In this structure, the coil forming body sets may be such that the coil forming bodies are wound overlapping each other while being offset 90° along the circumferential direction.

A second aspect of the invention relates to a rotary electric machine.

This rotary electric machine includes the stator according to the first aspect described above, and a rotor positioned on an inner peripheral side of the stator.

According to the stator and rotary electric machine based on the aspects described above, the creepage distance between a plurality of conductive wire exposed regions that are arranged on an outer peripheral surface of a coil assembly is able to be sufficiently maintained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional view of the structure of a rotary electric machine according to one example embodiment of the invention;

FIG. 2 is a side view of a stator as viewed from the direction of arrow II in FIG. 1;

FIG. 3 is a perspective view of a coil assembly as viewed from the direction of arrow III in FIG. 1;

FIG. 4 is a projection view of a coil forming body in the example embodiment;

FIG. 5 is a perspective view of the coil forming body in the example embodiment;

FIG. 6 is a perspective view of four coil forming bodies fit together in the, example embodiment;

FIG. 7 is a partial enlarged view of a weld in conductive wire exposed regions of two coil forming bodies in the example embodiment;

FIG. 8 is a partial enlarged plan view of the region encircled by VIII in FIG. 3;

FIG. 9 is a partial enlarged perspective view of the region encircled by VIII in FIG. 3;

FIG. 10 is a front view as viewed from the direction of arrow X in FIG. 9;

FIG. 11 is a sectional view taken along line XI in FIGS. 9 and 10;

FIG. 12 is a sectional view taken along line XII in FIGS. 9 and 10;

FIG. 13 is a sectional view taken along line XIII in FIGS. 9 and 10;

FIG. 14 is a partial enlarged plan view showing, with an arrow, the creepage distance between two adjacent conductive wire exposed regions in the region encircled by VIII in FIG. 3;

FIG. 15 is a partial enlarged perspective view showing, with an arrow, the creepage distance between two adjacent conductive wire exposed regions in the region encircled by VIII in FIG. 3;

FIG. 16 is a partial enlarged plan view of the positional relationship between a conductive wire exposed region and a curved portion in related art;

FIG. 17 is a partial enlarged perspective view of the positional relationship between the conductive wire exposed region and the curved portion in the related art;

FIG. 18 is a front view as viewed from the direction of arrow XVIII in FIG. 17;

FIG. 19 is a sectional view taken along line XIX in FIGS. 17 and 18;

FIG. 20 is a sectional view taken along line XX in FIGS. 17 and 18;

FIG. 21 is a sectional view taken along line XXI in FIGS. 17 and 18;

FIG. 22 is a partial enlarged plan view showing, with an arrow, the creepage distance between two adjacent conductive wire exposed regions in the related art; and

FIG. 23 is a partial enlarged perspective view showing, with an arrow, the creepage distance between two adjacent conductive wire exposed regions in the related art.

### DETAILED DESCRIPTION OF EMBODIMENTS

A stator and rotary electric machine according to example embodiments of the invention will now be described with reference to the accompanying drawings. The invention is not necessarily limited to numbers and amounts and the like that are referred to in the description below unless specifically stated. Further, like parts and corresponding parts will be denoted by like reference characters and redundant descriptions may not be repeated. Also, the use of the structures in the example embodiments in appropriate combinations is intended from the beginning.

### Example Embodiment

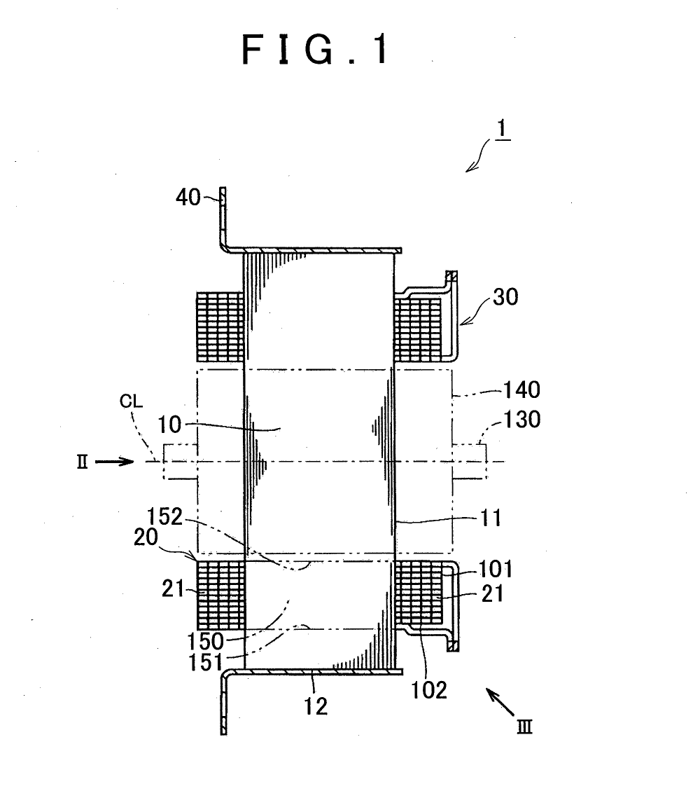

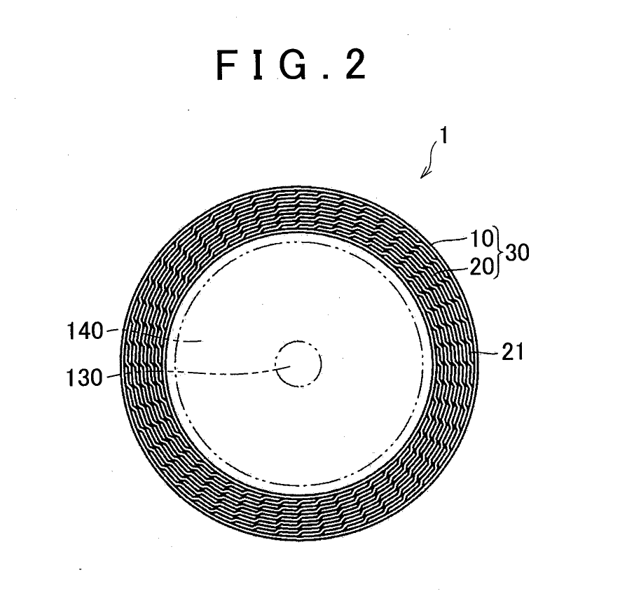

The general structure of a rotary electric machine 1 will be described with reference to FIGS. 1 and 2. FIG. 1 is a sectional view of the structure of the rotary electric machine 1 according to this example embodiment, and FIG. 2 is a side view of a stator as viewed from the direction of arrow II in FIG. 1. The rotary electric machine 1 includes a rotor 140, and a stator 30 provided on an outer periphery of the rotor 140. The rotor 140 is able to rotate about a shaft 130 (i.e., a rotation axis CL).

The stator 30 includes a stator core 10. An outer peripheral surface 12 of the stator core 10 is fit together with an outer cylindrical ring 40. The stator core 10 has a stator core thrust surface 11, and a coil end 20 is provided on this stator core thrust surface 11.

The coil end 20 is formed by a coil assembly 230 around which an insulation-coated conductive wire 21 is wound. The details of this coil assembly 230 will be described later. The coil end 20 is provided protruding out in a direction in which the rotation axis (CL) extends from the stator core thrust surface 11 (i.e., a thrust direction), and includes a coil end thrust surface 101 and a coil end outer peripheral surface 102. The coil end thrust surface 101 is provided on the stator core thrust surface 11 side, and the coil end outer peripheral surface 102 is provided on the stator core outer peripheral surface 12 side.

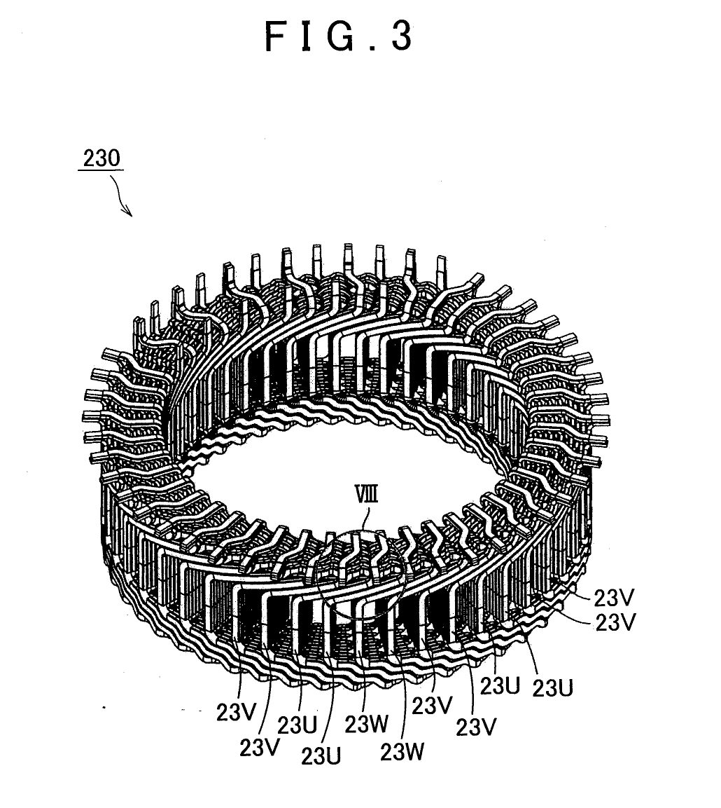

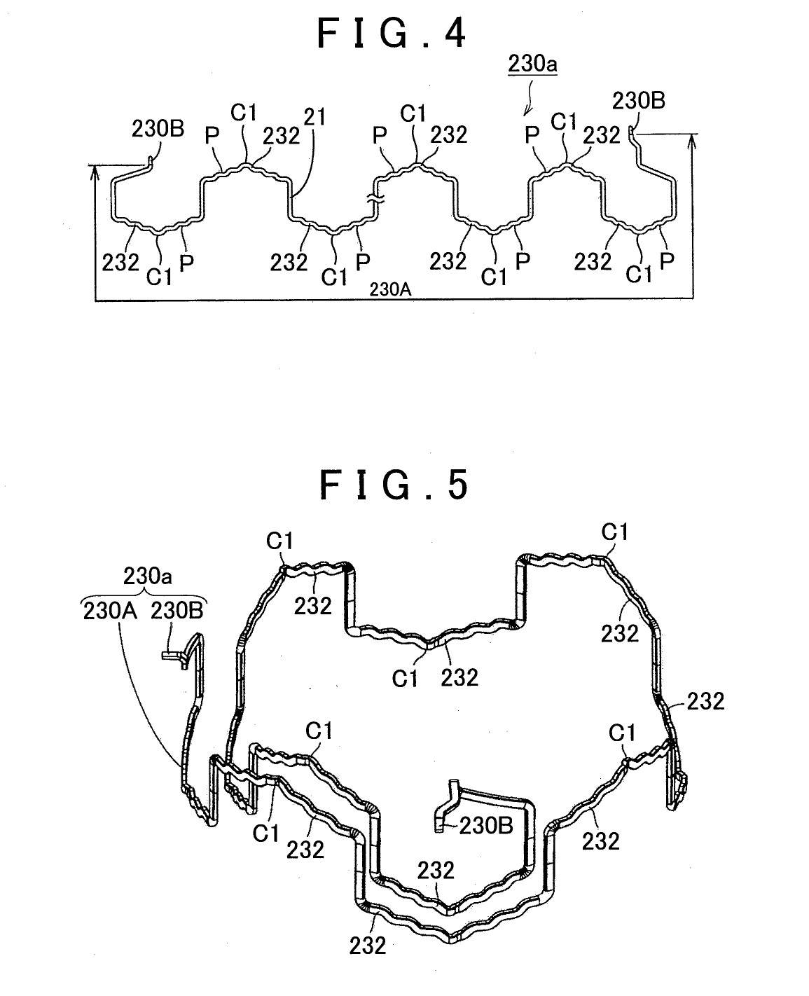

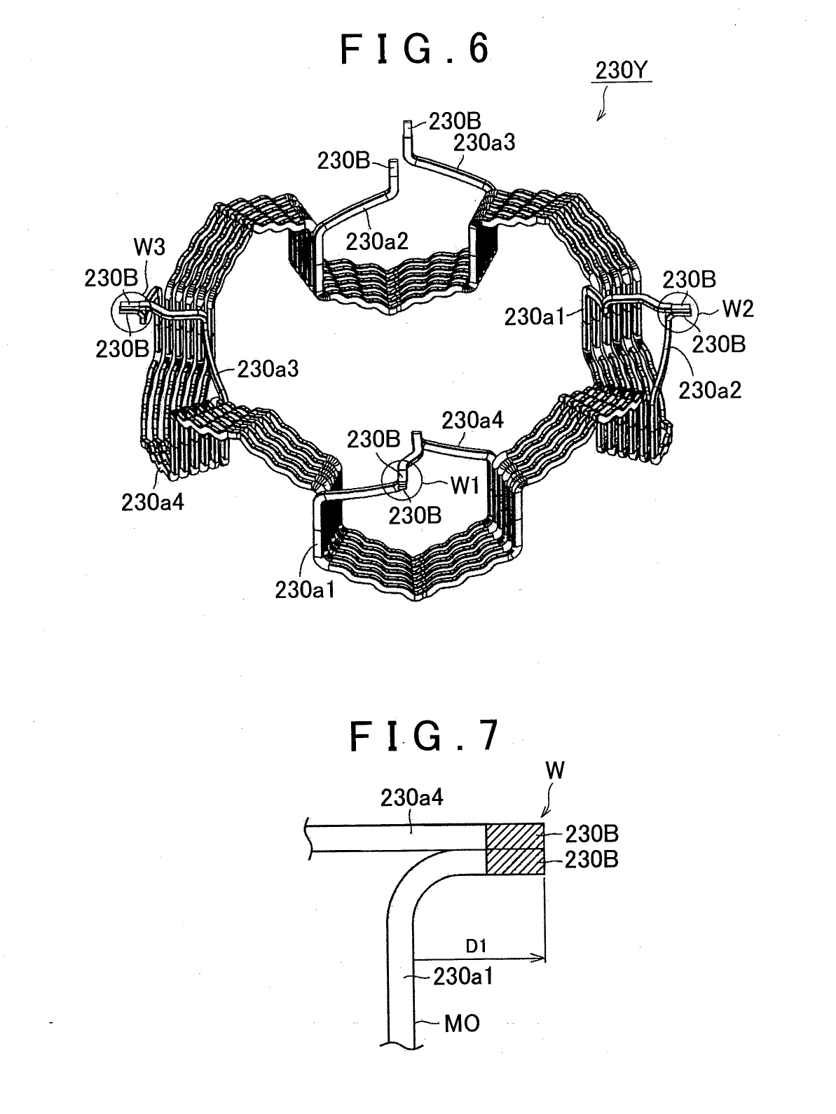

The structure of the coil assembly 230 will now be described with reference to FIGS. 3 to 7. FIG. 3 is a perspective view of a coil assembly 230 as viewed from the direction of arrow III in FIG. 1, FIG. 4 is a projection view of a coil forming body 230a, FIG. 5 is a perspective view of the coil forming body 230a, FIG. 6 is a perspective view of four coil forming bodies 230a1 to 230a4 fit together, and FIG. 7 is a partial enlarged view of a weld in conductive wire exposed regions of the coil forming body 230a1 and the coil forming body 230a4.

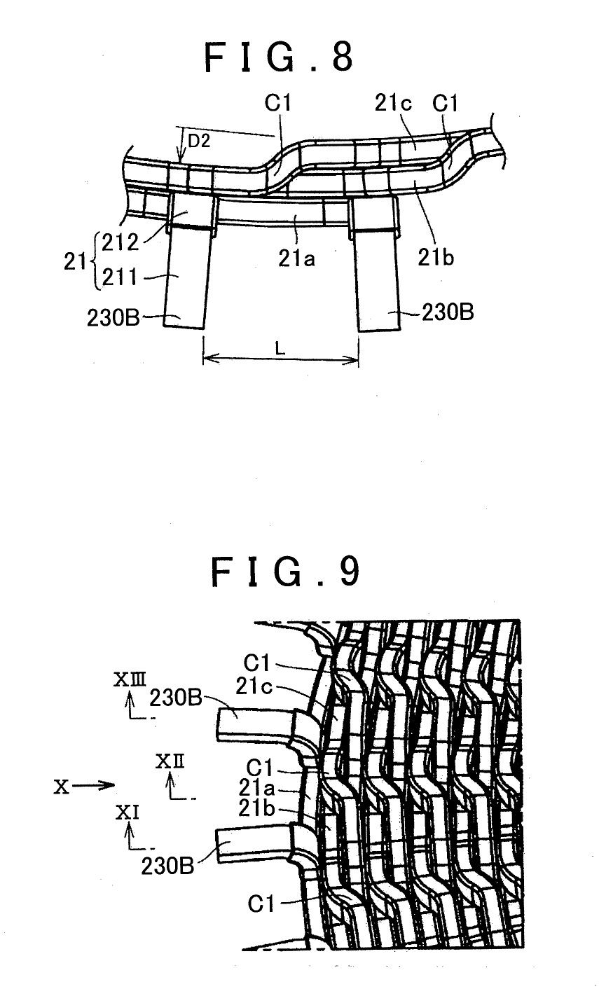

The coil assembly 230 is formed from a plurality of coil forming bodies. In this example embodiment, the coil assembly 230 is formed by preparing 12 of each of the four coil forming bodies 230a1 to 230a4 and winding them overlapping one another. Referring to FIGS. 4 to 6, one coil forming body 230a includes a coil region 230A and conductive wire exposed regions 230B. The coil region 230A is formed in a concavo-convex shape with alternately reversing generally U-shaped portions 232 each having a protruding portion P, using the insulation-coated conductive wire 21 in which a conductive wire 211 is coated by an insulation coating 212 (see FIG. 8), and is wound in a ring shape in the circumferential direction. The conductive wire exposed regions 230B are regions that are provided at both end portions of this coil region 230A, and in which the conductive wire 211 is exposed, and that are arranged at predetermined intervals along the outer peripheral surface on one end side of the coil assembly 230 in the direction in which the rotation axis (CL) extends. Also, when the coil forming body 230a is wound in the circumferential direction, a curved portion C1 (distance D2 in FIG. 8) that becomes larger in diameter on the outside in the radial direction is provided on each of the protruding portions P.

FIG. 5 is a perspective view of the coil forming body 230a wound in the circumferential direction. FIG. 6 is a view of a coil forming body set 230Y in which four coil forming bodies 230a1, 230a2, 230a3, and 230a4 that are formed just like the coil forming body 230a in FIG. 5 are wound overlapping one another while being offset 90° in the circumferential direction.

Conductive wire exposed regions 230B of each coil forming body 230a1, 230a2, 230a3, and 230a4 are provided extending toward the outside in the radial direction, except for the conductive wire exposed region 230B on one end side of each of the coil forming body 230a2 and the coil forming body 230a3. The conductive wire exposed region 230B on the one end side of each of the coil forming body 230a2 and the coil forming body 230a3 is provided extending in the direction in which the rotation axis CL extends (i.e., upward in FIG. 6).

In FIG. 6, the conductive wire exposed region 230B on one end side of the coil forming body 230a1 is connected in the region encircled by W1 in FIG. 6 to the conductive wire exposed region 230B on the other end side of the coil forming body 230a4, and a weld W is formed.

The conductive wire exposed region 230B on one end side of the coil forming body 230a2 is connected in the region encircled by W2 in FIG. 6 to the conductive wire exposed region 230B on the other end side of the coil forming body 230a1, and a weld W is formed.

The conductive wire exposed region 230B on one end side of the coil forming body 230a4 is connected in the region encircled by W3 in FIG. 6 to the conductive wire exposed region 230B on the other end side of the coil forming body 230a3, and a weld W is formed.

As shown in FIG. 7, in the region encircled by W1 in FIG. 6, the conductive wire exposed regions 230B are welded together with the conductive wire exposed region 230B of the coil forming body 230a4 placed on top of the conductive wire exposed region 230B of the coil forming body 230a1.

Also, the weld W of the conductive wire exposed regions 230B is positioned to the outside (by distance D1) of an outer surface MO of a coil region 230A that is positioned farthest outside in the radial direction of the coil forming body 230a1. The regions encircled by W2 and W3 in FIG. 6 are the same in this respect.

The coil assembly 230 shown in FIG. 3 is formed by preparing 12 of the coil forming body sets 230Y shown in FIG. 6 and winding them overlapping one another. This coil assembly 230 forms a coil assembly of a three-phase distributed winding stator structure that includes a V-phase coil 23V, a U-phase coil 23U, and a W-phase coil 23W.

Next, a creepage distance between two adjacent conductive wire exposed regions 230B, among a plurality of conductive wire exposed regions 230B arranged in the coil assembly 230, will be described with reference to FIGS. 8 to 15.

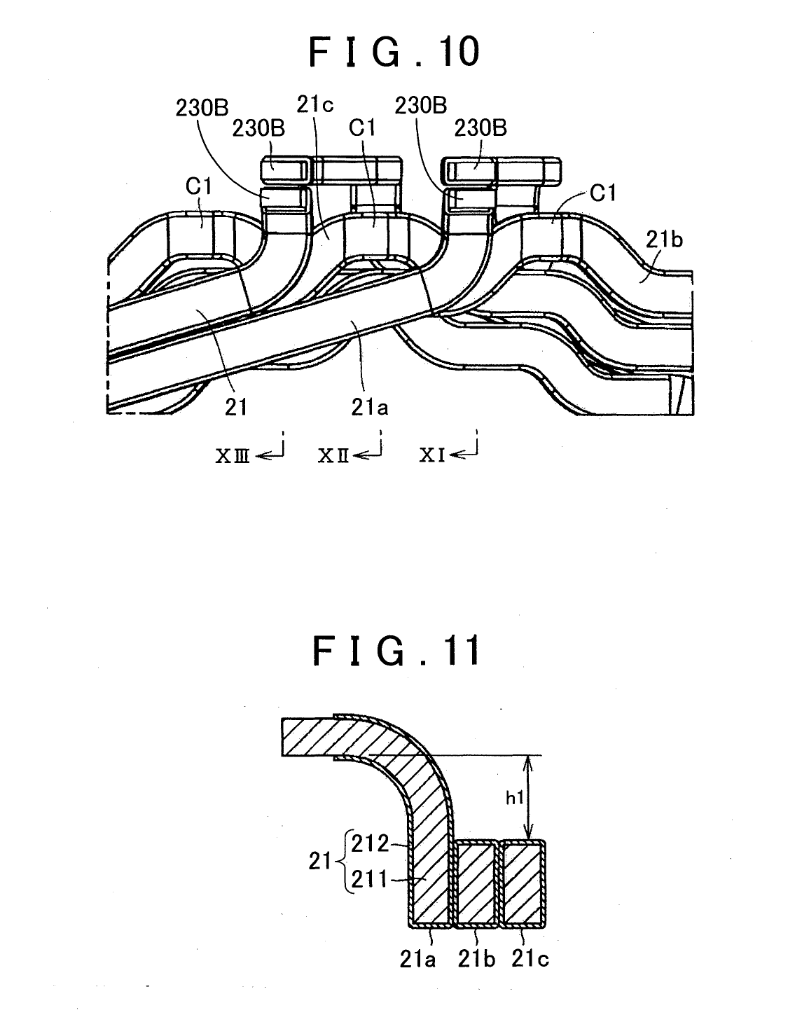

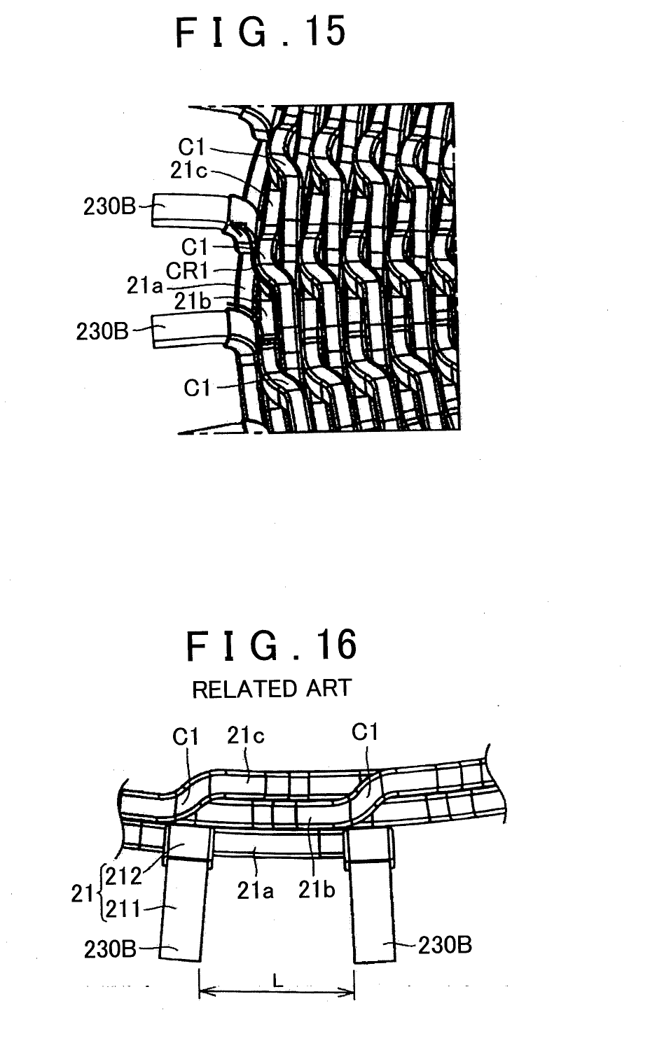

FIG. 8 is a partial enlarged plan view of the region encircled by VIII in FIG. 3, FIG. 9 is a partial enlarged perspective view of the region encircled by VIII in FIG. 3, FIG. 10 is a front view as viewed from the direction of arrow, X in FIG. 9, FIG. 11 is a sectional view taken along line XI in FIGS. 9 and 10, FIG. 12 is a sectional view taken along line XII in FIGS. 9 and 10, FIG. 13 is a sectional view taken along line XIII in FIGS. 9 and 10, FIG. 14 is a partial enlarged plan view showing, with an arrow, the creepage distance between two adjacent conductive wire exposed regions in the region encircled by VIII in FIG. 3, and FIG. 15 is a partial enlarged perspective view showing, with an arrow, the creepage distance between two adjacent conductive wire exposed regions in the region encircled by VIII in FIG. 3.

Referring to FIGS. 8 to 10, in the coil assembly 230 of this example embodiment, the conductive wire exposed regions. 230B are provided in a total of 48 locations on the circumference, and the distance between adjacent conductive wire exposed regions 230B is set as L.

Also, between one conductive wire exposed region 230B (i.e., the one on the right side in FIG. 8), from among the conductive wire exposed regions 230B positioned on both sides of a curved portion C1 positioned on the outermost periphery of the coil assembly 230, and an insulation-coated conductive wire 21c that forms the curved portion C1, is another insulation-coated conductive wire 21b.

Further, in this example embodiment, in order to position this other insulation-coated conductive wire 21b between the conductive wire exposed region 230B and the insulation-coated conductive wire 21c that forms the curved portion C1, the curved portion C1 is arranged in a substantially center position between conductive wire exposed regions 230B that are adjacent in the circumferential direction.

Arranging the curved portion C1 in a substantially center position between the conductive wire exposed regions 230B that are adjacent in the circumferential direction in this way enables the other insulation-coated conductive wire 21b, and the insulation-coated conductive wire 21c that forms the curved portion C1, to be arranged in positions a distance h1 below the lower surface of the conductive wire exposed regions 230B in the axial direction when viewed in a cross-section taken along line XI in FIGS. 9 and 10 (see FIG. 11).

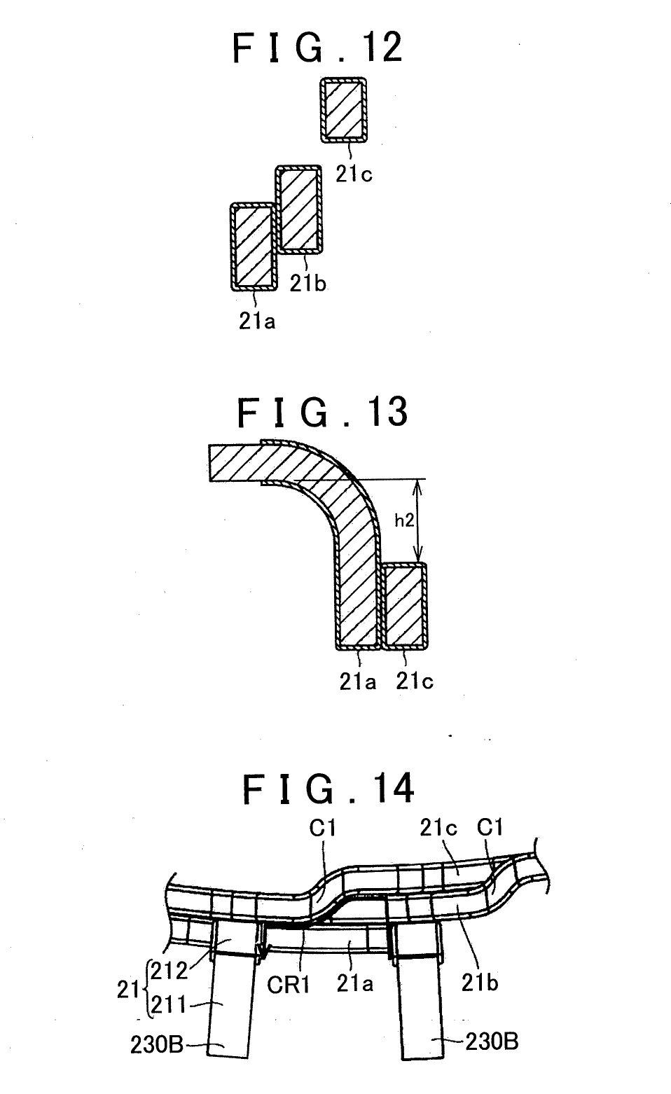

Also, when viewed in a cross-section taken along line XII in FIGS. 9 and 10, the insulation-coated conductive wire 21c that forms the curved portion C1 is able to arranged in a position not contacting the other insulation-coated conductive wire 21b (see FIG. 12). Further, when viewed in a cross-section taken along line XIII in FIGS. 9 and 10, the insulation-coated conductive wire 21c that forms the curved portion C1 is able to be arranged in a position a distance h2 below the lower surface of the conductive wire exposed regions 230B (see FIG. 13).

Accordingly, referring to FIGS. 14 and 15, the creepage distance between adjacently arranged conductive wire exposed regions 230B is able to be maintained at a distance that follows a path from the conductive wire exposed region 230B on the right side→the other insulation-coated conductive wire 21b→the insulation-coated conductive wire 21c→the conductive wire exposed region 230B on the left side, as shown by arrow CR1 in both drawings.

### Related Art

Here, the creepage distance between two adjacently arranged conductive wire exposed regions 230B of the coil assembly 230 according to related art will now be described with reference to FIGS. 16 to 23.

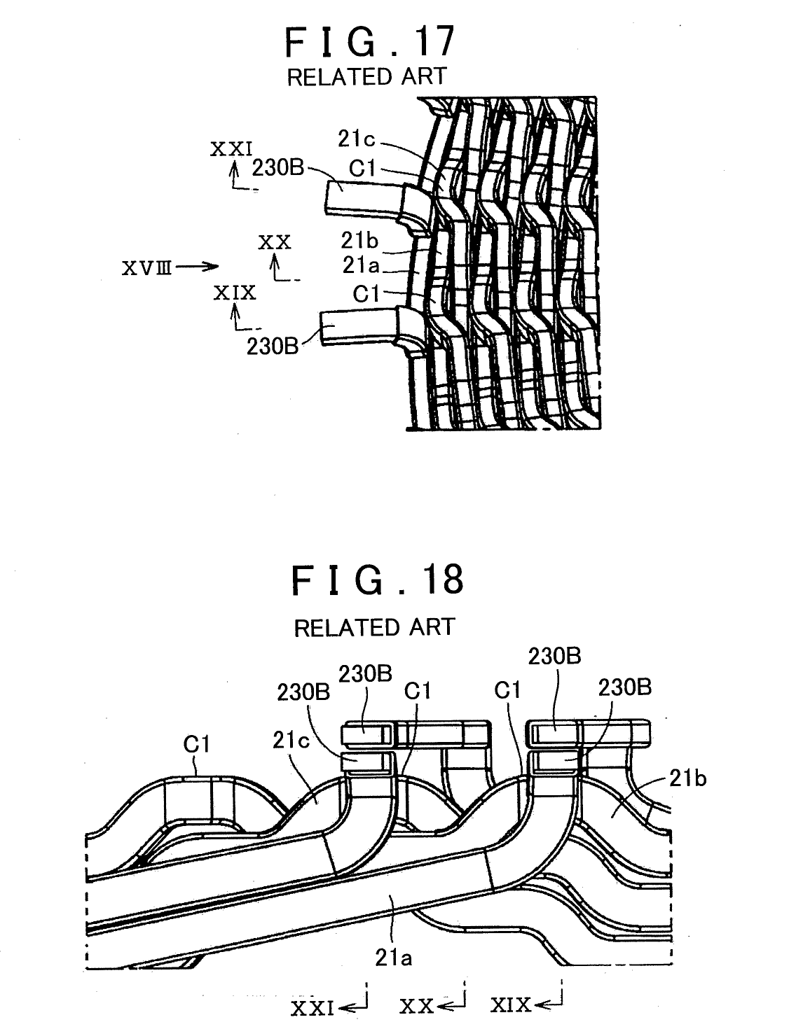

FIG. 16 is a partial enlarged plan view of the positional relationship between the conductive wire exposed region 230B and the curved portion C1 in the related art, FIG. 17 is a partial enlarged perspective view of the positional relationship between the conductive wire exposed region 230B and the curved portion C1 in the related art, FIG. 18 is a front view as viewed from the direction of arrow XVIII in FIG. 17, FIG. 19 is a sectional view taken along line XIX in FIGS. 17 and 18, FIG. 20 is a sectional view taken along line XX in FIGS. 17 and 18, FIG. 21 is a sectional view taken along line XXI in FIGS. 17 and 18, FIG. 22 is a partial enlarged plan view showing, with an arrow, the creepage distance between two adjacent conductive wire exposed regions 230B in the related art, and FIG. 23 is a partial enlarged perspective view showing, with an arrow, the creepage distance between two adjacent conductive wire exposed regions 230B in the related art.

Referring to FIGS. 16 to 18, in the coil assembly of the related art, the conductive wire exposed regions 230B are provided in a total of 48 locations on the circumference, and the distance between adjacent conductive wire exposed regions 230B is set as L. This is the same as it is with the coil assembly 230 of the example embodiment.

The curved portion C1 positioned on the outermost periphery of the coil assembly is positioned on a radial inside of the conductive wire exposed regions 230B when viewed from the radial direction. When the curved portion C1 is not arranged in a substantially center position between conductive wire exposed regions 230B that are adjacent in the circumferential direction, but is instead arranged on the radial inside of the conductive wire exposed regions 230B in the related art in this way, the insulation-coated conductive wire 21b that forms the curved portion C1 is arranged in a position that is substantially the same height as the position of the lower surface of the conductive wire exposed regions 230B, in the axial direction, when viewed in a cross-section taken along line XIX in FIGS. 17 and 18.

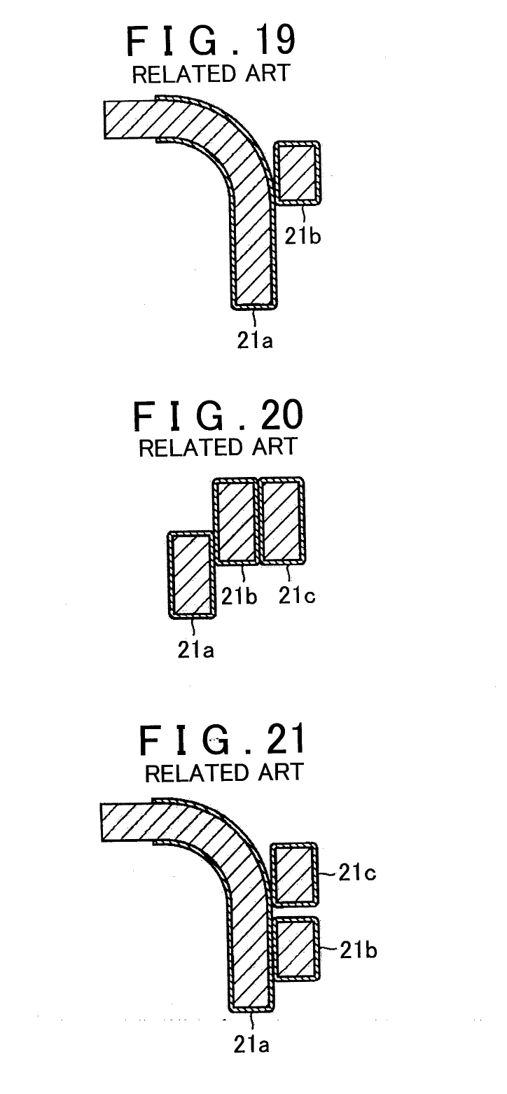

Also, the insulation-coated conductive wire 21b that forms the curved portion C1 is arranged in a position that is higher than another insulation-coated conductive wire 21a, when viewed in a cross-section taken along line XX in FIGS. 17 and 17 (see FIG. 20). When viewed in a cross-section taken along line XXI in FIGS. 17 and 18, the insulation-coated conductive wire 21b that forms the curved portion C1 contacts the insulation-coated conductive wire 21a that forms the conductive wire exposed region 230B (see FIG. 21).

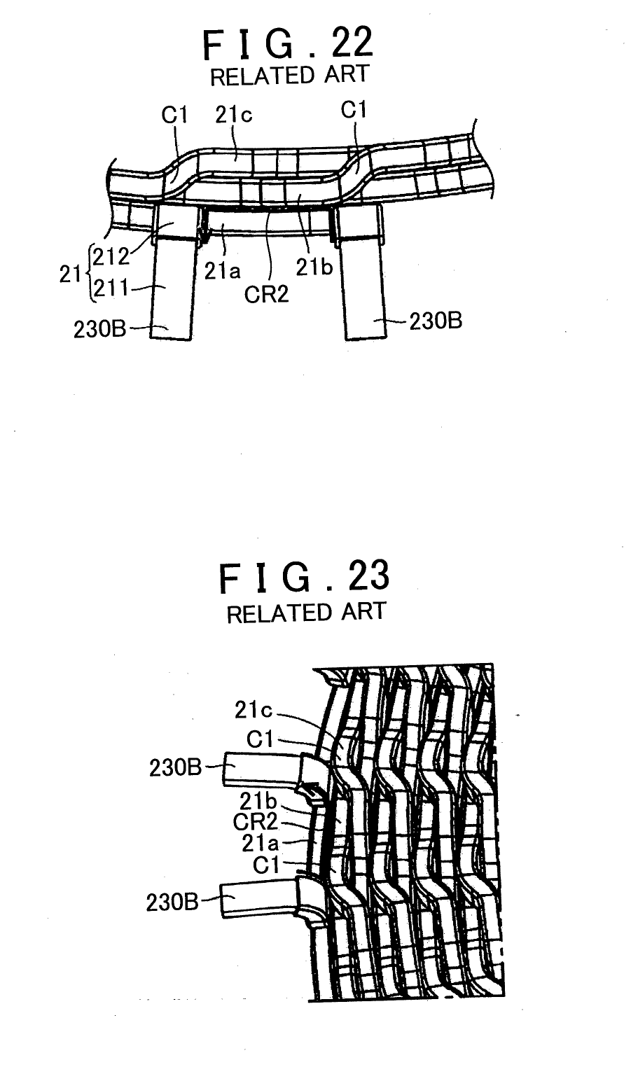

Accordingly, referring to FIGS. 22 and 23, the creepage distance between adjacently arranged conductive wire exposed regions 230B is a distance that follows a path from the conductive wire exposed region 230B on the right side→the other insulation-coated conductive wire 21a→the conductive wire exposed region 230B on the left side, as shown by arrow CR2 in both drawings.

### Operation And Effects

In this way, according to the stator 30 that uses the coil assembly 230 of the example embodiment, the creepage distance between two adjacently arranged conductive wire exposed regions 230B is able to be increased by the other insulation-coated conductive wire 21b being positioned between one of the conductive wire exposed regions 230B (i.e., the one on the right side in FIG. 8), from among the conductive wire exposed regions 230B positioned on both sides of the curved portion C1 positioned on the outermost periphery, and the insulation-coated conductive wire 21c that forms the curved portion C1. As a result, the performance reliability of the rotary electric machine that uses this stator 30 is able to be improved.

While example embodiments of the invention have been described, the example embodiments disclosed herein are in all respects merely examples and should in no way be construed as limiting. The scope of the invention is indicated not by the foregoing description but by the scope of the claims for patent, and is intended to include all modifications that are within the scope and meanings equivalent to the scope of the claims for patent.

1. A stator (30) that includes an annular coil assembly (230) around a center axis (CL) of the stator (30), wherein the coil assembly (230) is formed from a plurality of coil forming bodies (230a1 to 230a4), the stator (30) characterized in that:
each coil forming body (230a1 to 230a4) includes i) a coil region (230A) that is formed in a concavo-convex shape with generally U-shaped portions (232), each having a protruding portion (P), reversing alternately, formed by an insulation-coated conductive wire (21, 21a, 21b, 21c) in which a conductive wire (211) is coated with an insulation coating (212), and that is wound in an annular shape along a circumferential direction, and ii) a plurality of conductive wire exposed regions (230B) that are provided on end portions of the coil region (230A), and in which the conductive wire (211) is exposed, and that are arranged at predetermined intervals along an outer peripheral side on one end side of the coil assembly (230) in a direction in which the center axis (CL) extends;
the protruding portion (P) has a curved portion (C1) that increases in diameter on an outside in a radial direction, when the coil region (230A) is wound along the circumferential direction;
between one of the conductive wire exposed regions (230B), from among the conductive wire exposed regions (230B) that are positioned on both sides of one of the curved portions (C1) positioned on an outermost periphery of the coil assembly (230), and the insulation-coated conductive wire (21c) that forms the one curved portion (C1), is positioned the insulation-coated conductive wire (21b) of one of the coil forming bodies (230a2) that is different from another of the coil forming bodies (230a1) that has the insulation-coated conductive wire (21c); and
the insulation-coated conductive wire (21b) of the one coil forming body (230a2) forms another of the curved portions (C1).

2. The stator (30) according to claim 1, wherein each of the curved portions (C1) positioned on the outermost periphery of the coil assembly (230) is positioned in substantially a center between the conductive wire exposed regions (230B) that are adjacent in the circumferential direction.

3. The stator (30) according to claim 1 or 2, wherein the conductive wire exposed regions (230B) are provided extending toward the outside in the radial direction.

4. The stator (30) according to any one of claims 1 to 3, wherein the conductive wire exposed regions (230B) are positioned to an outside of an outer surface (MO) of the coil region (230A) that is positioned on an outermost side in the radial direction of the coil assembly (230).

5. The stator (30) according to any one of claims 1 to 4, wherein the coil assembly (230) is formed by a plurality of coil forming body sets (230Y), each of which is formed by four of the coil forming bodies (230a1 to 230a4).

6. The stator (30) according to claim 5, wherein the coil forming body sets (230Y) are such that the coil forming bodies (230a1 to 230a4) are wound overlapping each other while being offset 90° along the circumferential direction.

7. A rotary electric machine characterized by comprising:
the stator (30) according to any one of claims 1 to 6; and
a rotor (140) positioned on an inner peripheral side of the stator (30).
